(19) United States
(12) Patent Application Publication
(10) Pub. No.: US 2004/0258218 A1
(43) Pub. Date: Dec. 23, 2004

(54) Answering system for custmer service

(75) Inventors: Kuo-Rong Chen, Panchiao City (TW); Chun-Chung Lee, Taipei (TW); Cheng-Hung Huang, Miaoli (TW)

Correspondence Address: BACON & THOMAS, PLLC, 625 SLATERS LANE, FOURTH FLOOR, ALEXANDRIA, VA, 22314

(73) Assignee: Sin Etke Technology Co. , Ltd., Taipei City (TW)

(21) Appl. No.: 10/669,531

(22) Filed: Sep. 25, 2003

(30) Foreign Application Priority Data
Jun. 20, 2003 (TW) 92116809

(51) Int. Cl. H04M 11/00; H04M 1/64

(52) U.S. Cl. 379/88.22; 379/88.13

(57) ABSTRACT

An answering system comprises a database of back-end customer, a database of front-end customer, an exchange, terminals, a recording device, an interactive voice responding device, a data bus, and a host. In response to receiving a call from a front-end customer by the exchange, the host transfers the call to the terminal so that the operator can converse with the front-end customer, the recording device records the conversation as a voice file and generate an associated index, the host searches the database of back-end customer for finding a reply address of the back-end customer based on the index, and the host sends a reply message associated with the index to the back-end customer. The system can provide answers to a customer's questions an/or complaint in a substantially real time manner.

### BACKGROUND OF THE INVENTION

1. Field of the Invention

The present invention relates to an answering system and, more particularly, to an answering system for quickly providing answers to a customer's questions an/or complaint.

2. Description of Related Art

For providing better services to customers, more and more companies provide toll free phone numbers. As such, customers can call the toll free telephone to ask questions an/or express complaints. A well-known answering system for customer service is shown in FIG. 1. As shown, the system comprises an exchange 110, a recording device 120, a server controller 130, a custom database 140, and a plurality of terminals 150 operated by operators. In response to a toll free phone call from a person (i.e., front-end customer) by using a cellular phone or a typical telephone, the call is forwarded to the exchange 110 through a PSTN (Public Switch Telephone Network). In the exchange 110, a message is generated and sent to the server controller 130. In the server controller 130, the message is then sent to the terminal 150 being used by an operator based on a on duty shift list. At the same time, a physical link is established among the toll free phone call and the terminal 150 and the recording device 120. Thus, the operator can answer question(s) and/or listen complaint from the customer while the recording device 120 is recording the above conversation. The operator will answer the questions directly if the operator is able to. Otherwise, the operator will transfer the conversation recorded in a voice file to a customer service department (i.e., back-end customer) that will provide a satisfactory answer to the unanswered question thereafter and store it in a customer service database for future retrieval. However, the prior art suffered from several disadvantages. For example, a tag file containing basic data of a respective front-end customer was established by asking the front-end customer by the operator while the conversation was going. Hence, such process is time consuming and even may cause unpleasantness of the front-end customer if he/she is not willing to reply things asked by the operator. Further, it is quite often that the tag file cannot link the voice file recorded in the recording device 120 in a short period of time. Typically, a tedious process of manually linking the tag file and the voice file together is required. In view of the above, the back-end customer needs more time to get all necessary information of a specific front-end customer together. Thus, the goal of providing a quick, correct answer to the customer's question and/or complaint is compromised. Therefore, it is desirable to provide a novel call answering system for customer service in order to mitigate and/or obviate the aforementioned problems.

### SUMMARY OF THE INVENTION

The object of the present invention is to provide an answering system capable of automatically and quickly providing answers to a customer's questions an/or complaint. An object of the present invention is to provide an answering system comprising a database of back-end customers, an exchange, a plurality of terminals, a recording device, a data bus and a host. The database of back-end customers stores a plurality of records of back-end customers and each record includes a reply address. The exchange is electrically coupled to a PSTN and is adapted to receive a plurality of phone calls from the PSTN simultaneously. Each answering phone call number is corresponding to one of the plurality of back-end customers. The data bus is electrically coupled to the database of back-end customer, the exchange, the terminals, and the recording device respectively. The host electrically coupled to the data bus and comprising an on duty shift list of a plurality of operators operating the terminals, wherein in response to receiving a phone call from a front-end customer by the exchange, the host transfers the call to one of the terminals based on the on duty shift list so that the operator operating the dispatched terminal can converse with the front-end customer, the recording device is commanded to record the conversation as a voice file and generate an associated index, the host further searches the database of back-end customer for finding a reply address of a back-end customer to which the call being corresponding, and the host sends a reply message associated with the associated index to the corresponding back-end customer subject to the reply address.

Other objects, advantages, and novel features of the invention will become more apparent from the detailed description when taken in conjunction with the accompanying drawings.

### BRIEF DESCRIPTION OF THE DRAWINGS

FIG. 1 presents schematically a system architecture of a conventional answering system for customer service;

FIG. 2 presents schematically a system architecture of an answering system for customer service in accordance with the invention;

FIG. 3 is a flow chart illustrating a process in accordance with the present invention;

FIG. 4 shows a screen of a terminal for servicing the custom phone call in accordance with the present invention; and

FIGS. 5 to 9 are front plan views of a cellular phone illustrating steps of sending a short message in accordance with the present invention.

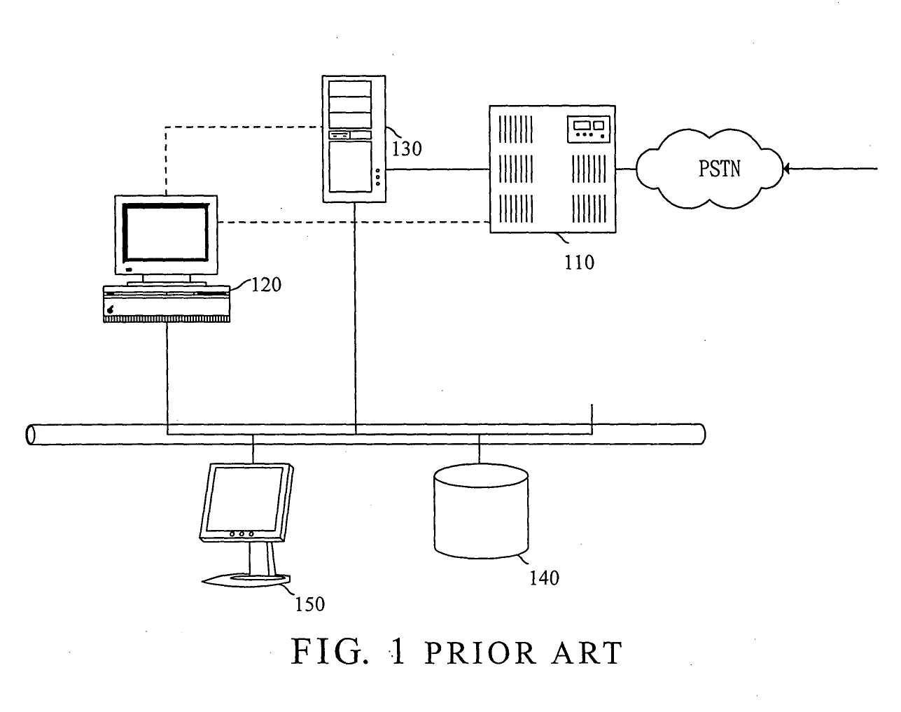

### DETAILED DESCRIPTION OF THE PREFERRED EMBODIMENT

While the following description of a preferred embodiment of the invention details an answering system for customer service employed by a motor company, it is appreciated by those skilled in the art that the invention is equally applicable to any of other embodiments such as an answering system for assisting customers to buy stock adopted by a stock company, an answering system for customer service adopted by an insurance company, or an answering system for customer service adopted by a credit card company.

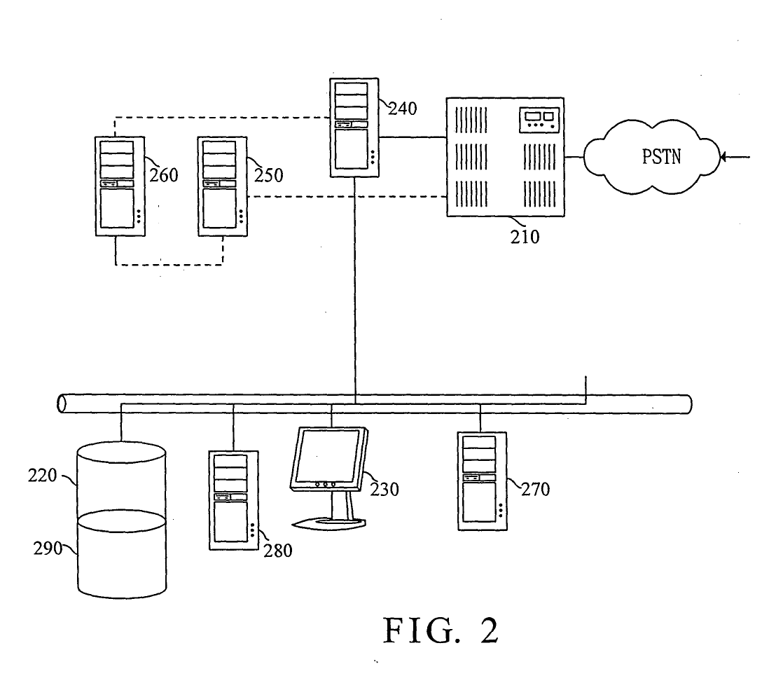

With reference to FIG. 2, there is shown a system architecture for an answering system for customer service constructed in accordance with the invention comprising an exchange 210, a database of front-end customer 220, a database of back-end customer 290, a plurality of terminals 230, a host 240, a recording device 250, an interactive voice responding device 260, an integration server 270, an interface server 280, and a data bus 3. The data bus 3 is electrically coupled to the database of back-end customer 290, the exchange 210, the terminals 230, the recording device 250, and the host 240 respectively.

The exchange 210 receives a phone call from a PSTN. Each phone call number is corresponding to a back-end customer. The database of front-end customer 220 stores a plurality of records of front-end customers. The database of back-end customer 290 stores a plurality of records of back-end customers and a plurality of reply addresses. The terminals 230 can process the call of a front-end customer who may ask questions an/or express complaints.

The recording device 250 records the phone call of the front-end customer in a voice file. The interactive voice responding device 260 stores a plurality of records of responding voice messages recorded by the back-end customers. When a call for a specific back-end customer answering service, according to the index of the back-end customer, the corresponding responding voice message will be played. The integration server 270 integrates information from the exchange 210 and the host 240. The interface server 280 is an interface between the exchange 210 and the integration server 270 and operates similar to the host 240.

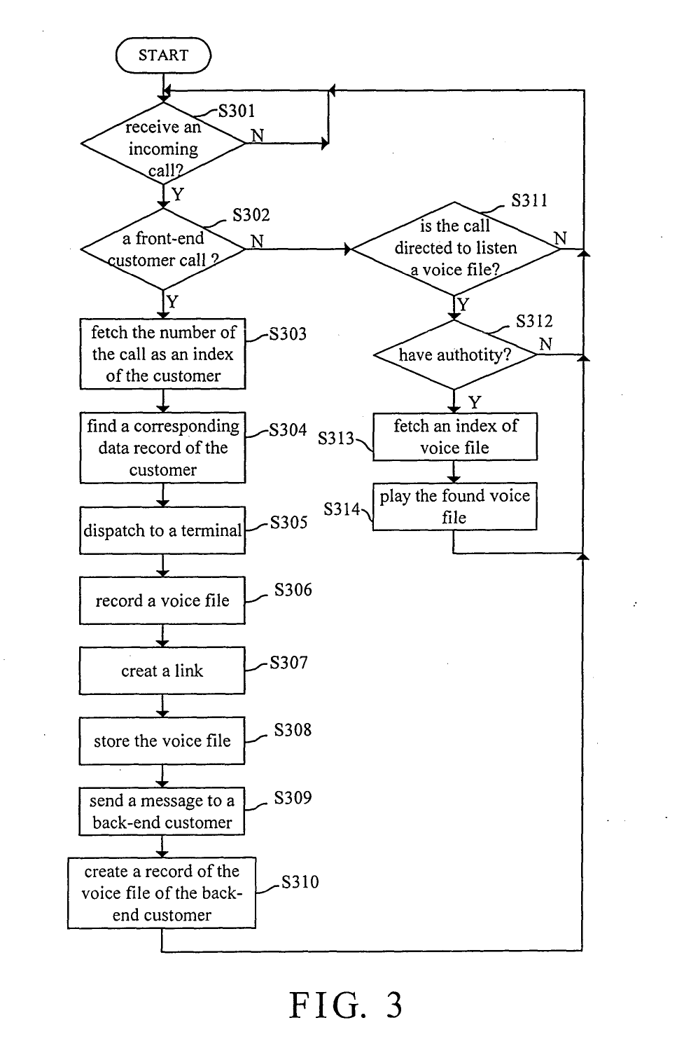

With reference to FIG. 3, steps of a process of the invention will now be described in detail below. First, the exchange 210 determines whether an incoming call has been received from the PSTN (step S301). If yes, the process goes to step S302. Otherwise, the process loops back to itself for continuation. In step S302, the exchange 210 determines whether the incoming call is initiated from a complainant (a front-end customer) by using a cellular phone or a typical telephone and determines whether the incoming call is corresponding to the toll free answering phone number provided by a Yulon Motor Company, Ltd. (an back-end customer). If yes, the process goes to step S303. Otherwise, the process jumps to step S311. In step S303, the exchange 210 fetch the number of the phone as an index of the person who dials the call (i.e., front-end customer). The toll free answering phone number provided by the back-end customer is taken as an index of the back-end customer.

The exchange 210 comprises a circuitry for receiving a plurality of calls from the PSTN simultaneously. For example, an exchange 210 such as exchange 61 C M1 by Nortel can receive up to 1,000 calls from the PSTN simultaneously. The 1,000 numbers may be from 0800-000000 to 0800-000999 in which numbers 0800-000000 to 0800-000089 are reserved as customer service telephone numbers of the Yulon Motor Company, Ltd. (a back-end customer A), numbers 0800-000090 to 0800-000099 are reserved as telephone numbers dialed by operators of the Yulon Motor Company, Ltd. (the back-end customer A) for listening voice files, numbers 0800-000100 to 0800-000189 are reserved as customer service numbers of a back-end customer B, and numbers 0800-000190 to 0800-000199 are reserved as telephone numbers dialed by operators of the back-end customer B for listening voice files.

When a custom (a front-end customer) who bought a product of the Yulon Motor Company, Ltd. (back-end customer A) initiates a call to the toll free number 0800-000000 provided by the Yulon Motor Company, Ltd. (back-end customer A) by using a cellular phone (i.e., terminal) numbered 0900-123456, the exchange 210 will create an ID-A tag of the Yulon Motor Company, Ltd. (back-end customer A) and fetch the number (e.g., 0900-123456) of the cellular phone as an index of the front-end customer. (step 303)

In step S304, the host 240 finds a corresponding data record from the database of front-end customer 220 based on the index (0900-123456) of the front-end customer. The data record of front-end customer may contain information about name, telephone number, sex, birth date, address, and other related data. The host 240 fetches a responding voice message of the Yulon Motor Company, Ltd. (back-end customer A) from the interactive voice responding device 260 according to the tag ID_A. The responding voice message of the Yulon Motor Company, Ltd. is sent to the mobile phone or the conventional telephone of the complainant (a front-end customer) by the exchange 210. The responding voice message will be played and the complainant (a front-end customer) will hear this responding voice message from the cellular phone or the conventional telephone. An exemplary responding voice message may be: “Thank you-for calling Yulon Motor Company. Please ask your question . . . . ”

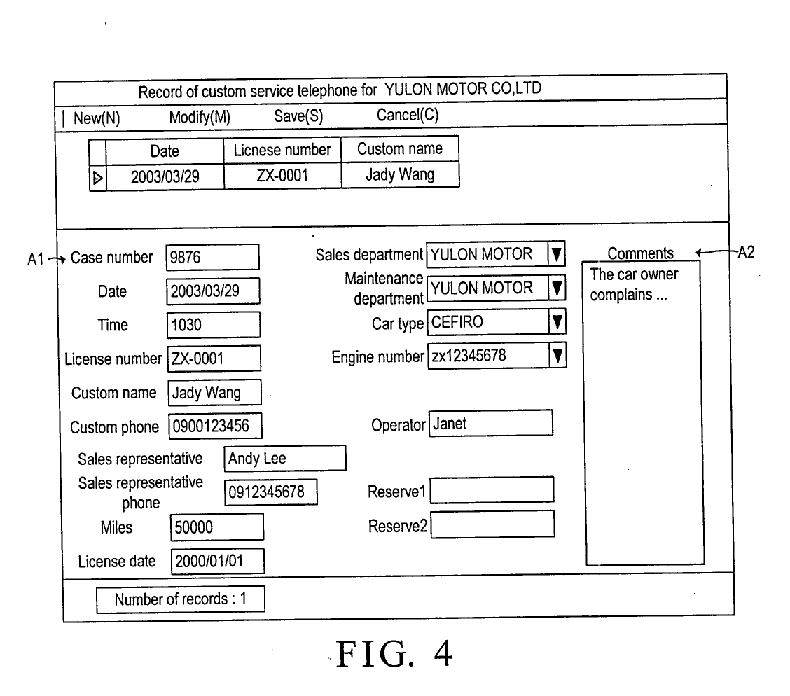

The integration server 270 integrates information from the exchange 210 and the host 240. The interface server 280 is an interface between the exchange 210 and the integration server 270 and operates similar to the host 240.In step S305, the interface server 280 dispatches the data record of front-end customer and the call to the terminal 230 by referring to a on duty shift list (not shown). Also, the data record of front-end customer is shown on the screen of the terminal 230 as illustrated in FIG. 4. As shown, basic data of the front-end customer has been displayed in respective fields. Hence, there is no need for the operator to fill out again by asking the front-end customer. Moreover, case number 9876 in field A1 is automatically entered. In step S306, the host 240 commands the recording device 250 to record the conversation to be conducted immediately after the call is connected to the operator. The recording device 250 will record the conversation in a voice file and will take the case number (e.g., 9876) as an index of the voice file. For example, a voice file may be stored as ID_A_{—}9876.MP3, where ID_A is the tag ID_A of the Yulon Motor Company, Ltd. (the back-end customer A) and 9876 is the case number of this customer service.

The operator enters abstract of the conversation in field A2 (i.e., comments) on the terminal 230 while conversing with the front-end customer. The abstract is stored in a text file (e.g., ID_A_{—}9876.TXT). In step S307, the interface server 280 links the voice file, the abstract text file ID_A_{—}9876.TXT, and the data record of front-end customer together based on the index of the voice file (e.g., case number 9876 shown in field A1 of FIG. 4) so that the voice file can correspond to the abstract text file and the data record of the front-end customer. In other words, it is possible of searching a corresponding voice file, the abstract text file, and the data record of front-end customer by referring to the index (e.g., 9876). In step S308, the recording device 250 stores the link of the voice file, the abstract of the text file, and the data record of front-end customer based on the index of the voice file (e.g., 9876). The link can be used either for future retrieval by the back-end customer A when a customer service (i.e., call) originated from the back-end customer or for accessing the voice file by the system software.

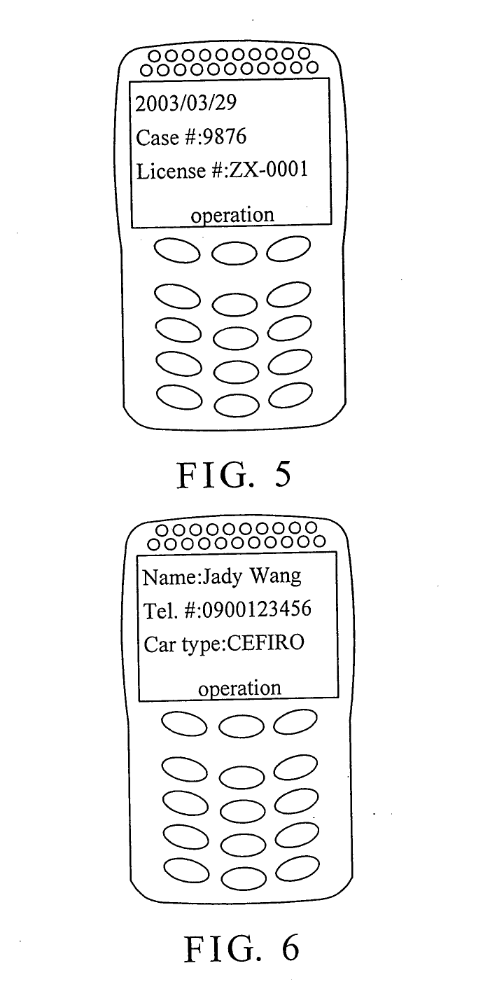

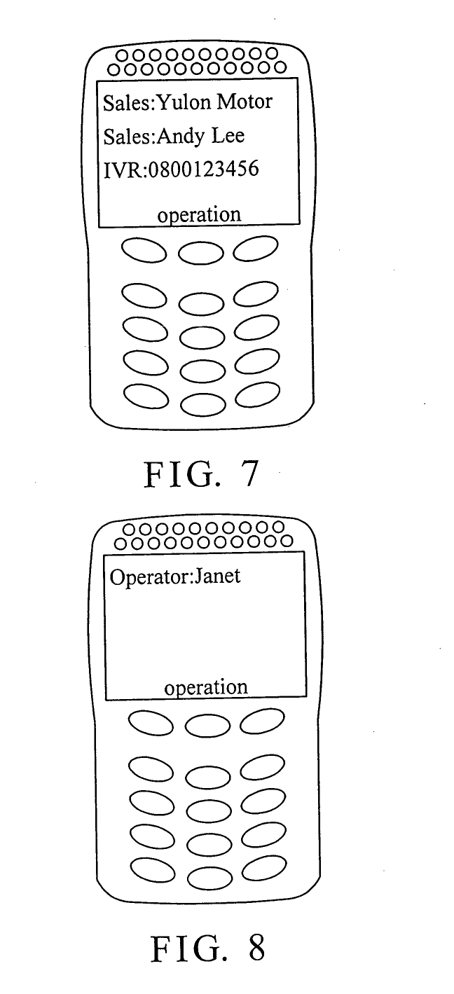

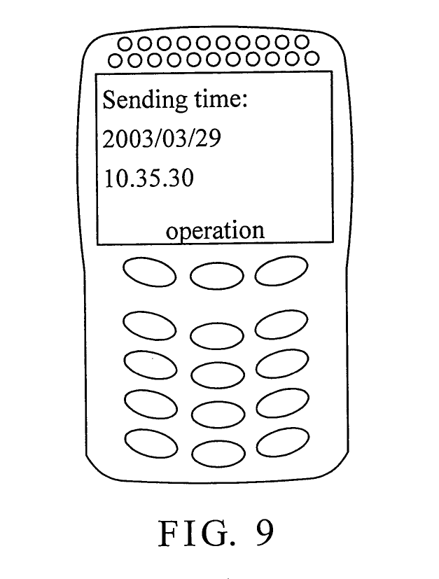

In step S309, the interface server 280 sends a message to the Yulon Motor Company, Ltd. (the back-end customer A) based on a reply address stored in the database of back-end customer 290. The message may be an e-mail having content similar to that shown in FIG. 4 or a short message having content similar to that shown in FIGS. 5 to 9. The reply address can be a telephone number of the short message or an address of the e-mail.

The message may contain the index of the voice file (e.g., case number 9876 shown in FIG. 4 or FIG. 5). In such a manner, the Yulon Motor Company, Ltd. (the back-end customer A) may know the message containing the updated data of a front-end customer in substantially real time as compared to a long waiting time for reply as experienced in the prior art. Note that the Yulon Motor Company, Ltd. (the back-end customer A) still can know the important content of the call by referring to the sent short message even when the operator is not in office temporarily.

In step S310, the interface server 280 creates a record of the Yulon Motor Company, Ltd. (the back-end customer A) related to the voice file. Further, the voice file, the abstract text file, and the data record of front-end customer are either regularly sent to the Yulon Motor Company, Ltd. (the back-end customer A) by e-mail or stored in a tape cassette or CD-ROM prior to sending to the Yulon Motor Company, Ltd. (the back-end customer A).

In a case of receiving the e-mail or short message by an operator of the Yulon Motor Company, Ltd. (the back-end customer A), the operator will dial one of the numbers 0800-000090 to 0800-000099 for listening the voice file. In step S311, the exchange 210 determines whether a call from a PSTN is corresponding to one of the numbers 0800-000090 to 0800-000099

. If yes, the process goes to step S312. Otherwise, the process loops back to step S301. In step S312, the host 240 performs a verification procedure for determining whether the operator has the authority to listen the stored voice file of the Yulon Motor Company, Ltd. (the back-end customer A). The operator of the Yulon Motor Company, Ltd. (the back-end customer A) is required to input a username and a password for identification. The exchange 210 then fetches the username and the password. The host 240 compares the username and the password with the content in an identification table to determine this username and password has authority to listen the corresponding voice file of the Yulon Motor Company, Ltd. (the back-end customer A): The identification table has a plurality of usernames and passwords, and each username and password is corresponding to a back-end custom respectively. If the comparison is positive, the process goes to step S313. Otherwise, the process loops back to step S301.

In step S313, the interactive voice responding device 260 prompts an input voice file for inputting a number as an associated index of a corresponding voice file. The exchange 210 then fetches the associated index (e.g., case number 9876 shown in FIG. 4 or FIG. 5) and sends the associated index number to the host 240. The host 240 then sends the associated index to the recording device 250. Next, the recording device 250 searches a corresponding voice file from the database of voice file of the back-end customer A based on the associated index. In step S3 14, the recording device 250 plays the found corresponding voice file through the exchange 210.

In brief, the operator of the back-end customer A still can obtain a corresponding voice file of an ongoing call initiated by a customer by receiving an e-mail or short message by using a cellular phone through a PSTN even when the operator is not in office. As such the operator can answer the question asked by the customer in the call in a substantially real time manner. As a result, customer service is improved.

Although the present invention has been explained in relation to its preferred embodiment, it is to be understood that many other possible modifications and variations can be made without departing from the spirit and scope of the invention as hereinafter claimed.

What is claimed is:

1. An answering system, comprising:
a database of back-end customer for storing a plurality of records of back-end customers, each record including a reply address;
an exchange electrically coupled to a PSTN and being adapted to receive a plurality of calls from the PSTN simultaneously, each call being corresponding to one of the back-end customers;
a plurality of terminals;
a recording device;
a data bus electrically coupled to the database of back-end customer, the exchange, the terminals, and the recording device respectively; and
a host electrically coupled to the data bus and comprising an on duty shift list of a plurality of operators operating the terminals;
wherein in response to receiving a call from a front-end customer by the exchange, the host dispatches the call to one of the terminals based on the on duty shift list so that the operator operating the dispatched terminal can converse with the front-end customer, the recording device is commanded to record the conversation as a voice file and generate an associated index, the host further searches the database of back-end customer for finding a reply address of a back-end customer to which the call being corresponding, and the host sends a reply message associated with the associated index to the corresponding back-end customer subject to the reply address.

2. The answering system as claimed in claim 1, wherein the reply address of the corresponding back-end customer is a telephone number.

3. The answering system as claimed in claim 2, wherein the reply message for the corresponding back-end customer is a short message and the telephone number is the telephone number of a cellar phone for receiving the short message.

4. The answering system as claimed in claim 1, wherein the reply message is an e-mail and the reply address of the corresponding back-end customer is an e-mail address.

5. The answering system as claimed in claim 1, further comprising a database of front-end customer electrically coupled to the data bus and being adapted to store a plurality of records of front-end customers each having a telephone number, the exchange is further operable to fetch the telephone number of the front-end customer who initiates the call, the host compares the telephone number of the front-end customer with a plurality of telephone numbers of the records stored in the database of front-end customer for finding a corresponding record of the front-end customer, and displays the corresponding record of the front-end customer on the terminal.

6. The answering system as claimed in claim 1, further comprising an interactive voice responding device electrically coupled to the data bus and being adapted to store a plurality of records of responding voice messages, each record of responding voice message being corresponding to a respective one of the back-end customers, the interactive voice responding device is able to play a corresponding one of the records of responding voice messages based on the back-end customer to which the call being corresponding before connecting the call from the exchange to the terminal.

7. The answering system as claimed in claim 1, wherein the host further comprises an identification table containing a plurality of records of usernames and passwords associated with the back-end customers so that in response to receiving a call from one of the back-end customers by the exchange for listening a voice file and the listening telephone call includes a input password with an associated index of the voice file, the host compares the input password and the password in the identification table to determine whether the back-end customer has the authority to listen the corresponding voice file of the back-end customers in the recording device or not, if yes, the host searches the corresponding voice file in the recording device subject to the associated index and then sends the corresponding voice file to the back-end customer.
